(19) United States
(12) Patent Application Publication
(10) Pub. No.: US 2012/0006933 A1
(43) Pub. Date: Jan. 12, 2012

(54) HOSE-GUIDE TOOL FOR SPRAYING AGRICULTURAL CHEMICALS

(76) Inventor: Yong Gun An, Kyungbuk (KR)

(21) Appl. No.: 13/256,628

(22) PCT Filed: Mar. 23, 2009
(86) PCT No.: PCT/KR2009/001467

§ 371 Date: Sep. 14, 2011

(30) Foreign Application Priority Data
Mar. 19, 2009 (KR) 10-2009-0023485

(51) Int. Cl. B65H 57/14; A01M 7/00

(52) U.S. Cl. 242/615.2

(57) ABSTRACT

The present invention relates to a hose-guide tool for spraying agricultural chemicals. More specifically, the hose, connected to an agricultural chemical tank, can be easily manipulated during the course of spraying agricultural chemicals on crops, allowing a single user to easily and evenly spray agricultural chemicals without the hose damaging the crops. The present invention comprises: a fixing pole grounded in a field to hold the hose connected to the agricultural chemical tank for spraying agricultural chemicals on crops; a fixing pipe, which is connected to the fixing pole for preventing the hose from sliding out of the upper or lower side of the pole; and a rotating guide pipe which is statically attached to the fixing pipe to guide the hose while it is manipulated

### TECHNICAL FIELD

The present invention relates to a hose-guide tool for spraying agricultural chemicals, more specifically, hose-guide tool for spraying agricultural chemicals which guides a hose such that the hose can be easily pulled while agricultural chemical-spraying work is done pulling the hose connected to an agricultural chemical tank for spraying the agricultural chemicals on crops and also allows a single worker alone to stably and conveniently spray the agricultural chemicals while preventing the crops from being damaged by the hose.

### BACKGROUND ART

In general, agricultural chemical sprayer is connected to the agricultural chemical tank by a hose, wherein this hose is wound on a hose drum and a tip of the hose is equipped with a spray nozzle for spraying the agricultural chemicals. When spraying agricultural chemicals on the crops cultivated in a wide area by using such an agricultural chemical sprayer, a worker sprays the agricultural chemicals on the crops through the spray nozzle equipped on the tip of the hose, pulling the hose, while moving along a pathway between the crops defined by a rice field furrow or patch furrow.

Conventionally, in the state that the agricultural chemical tank is fixedly installed in a given position in order to spray the agricultural chemicals by using such an agricultural chemical sprayer, when an agricultural chemical spraying worker performs agricultural chemical spraying work, pulling the hose such that unwound part thereof is lengthened, while moving along the pathway between the crops, at least two workers are needed and it is difficult for a single worker alone to spray the agricultural chemicals. Accordingly, there is a problem that since a separate assistant worker except for the agricultural chemical spraying worker should guide the hose such that it can be easily pulled and guide a direction of the hose such that the hose can be prevented from damaging the crops by contacting therewith, cost burden becomes heavier accordingly and work efficiency is greatly reduced.

### SUMMARY OF THE INVENTION

Hereinafter, a preferred example of construction of the present invention will be described in detail with reference to the attached drawings as follows. In explanation of the present invention, concrete description of related known functions or constructions will be omitted if it is determined that they may unnecessarily obscure a gist of the present invention.

The present invention relates to a hose-guide tool for spraying agricultural chemicals which can guide the hose (40) such that pulling action of the hose is facilitated and the hose does not deviate from the pathway between the crops, when a worker sprays the agricultural chemicals on the crops through the spray nozzle (45) equipped on the tip of the hose, pulling the hose (40) such that unwound part thereof is lengthened, while moving along a pathway between the crops defined by a rice field furrow or patch furrow in the case of spraying the agricultural chemicals on the crops cultivated in a wide area by using the agricultural chemical sprayer.

A hose-guide tool (A) of the present invention is characterized in that it comprises a fixed pole (10) fixedly installed in a crop cultivation field; a fixed pipe (20) joined with the fixed pole (10) to prevent the hose (40) from deviating upward and downward; and a rotating guide pipe (30) rotatably joined with the fixed pipe (20) to guide pulling action of the hose (40).

The fixed pole (10) consists of a rod of a predetermined length, and a lower end part of the pole is made in the form of a needle such that the fixed pole can be easily driven into ground surface of agricultural cultivation field, and fixing pin-engaging holes (12) are formed in multi-stage on side surface of upper end part of the fixed pole, and a fixing pin (14) can selectively engage the pin-engaging holes (12), whereby the fixed pipe (20) is prevented from deviating upward from a position of joining height and can be kept in a fixed state by the fixing pin (14).

The fixed pipe (20) has a pedestal end part (22) integrally formed on outer circumferential surface of its lower part for supporting the rotating guide pipe (30), and thread engaging part (24) is formed on outer circumferential surface of its upper end part, on which engaging part is fixedly screwed a ring-like catching end part (26), and the rotating guide pipe (30) is joined on the outer circumferential surface between the pedestal end part (22) and the catching end part (26), and the pedestal end part (22) also performs a supporting function of making the fixed pipe (20) brought into close contact with the ground surface.

The rotating guide pipe (30) is rotatably joined between the pedestal end part (22) and the catching end part (26) and has a plurality of concavo-convex parts (32) formed on its outer circumferential surface for preventing slipping of the hose (40), and therefore rotation action of the rotating guide pipe (30) is facilitated by the fact that the hose (40) is brought into close contact with the concavo-convex parts (32), which hose is pulled contacting with the rotating guide pipe (30).

Furthermore, the hose (40) is provided in a state of being connected to agricultural chemical tank (50) and wound on a hose drum (60), and the agricultural chemicals is sprayed through a spray nozzle (45) equipped on a tip of the hose (40) while the hose is pulled such that unwound part thereof is lengthened.

### BRIEF DESCRIPTION OF THE DRAWING

FIG. 1 is a perspective view showing a hose-guide tool of the present invention.

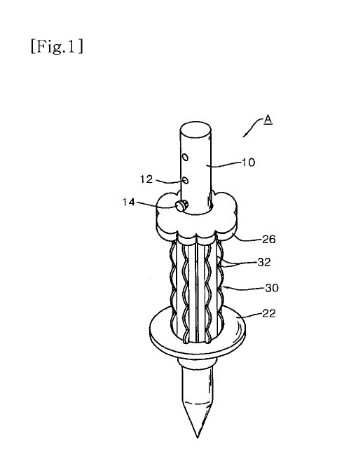

FIG. 2 is an exploded perspective view showing a hose-guide tool of the present invention.

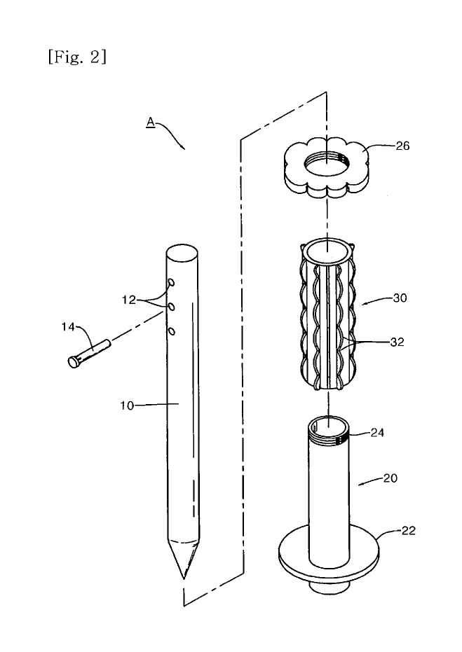

FIG. 3 is a front view showing a hose-guide tool of the present invention.

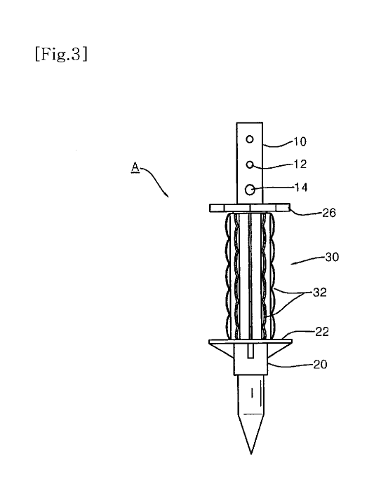

FIG. 4 is a sectional view showing a hose-guide tool of the present invention.

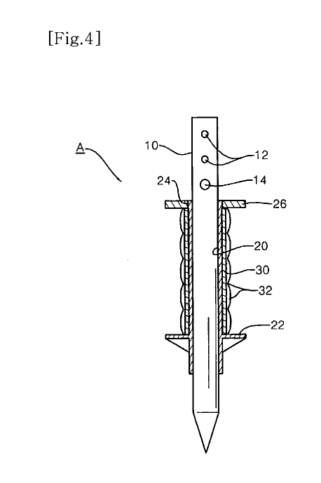

FIG. 5 is an exemplary front view showing a state of the hose-guide tool of the present invention being installed.

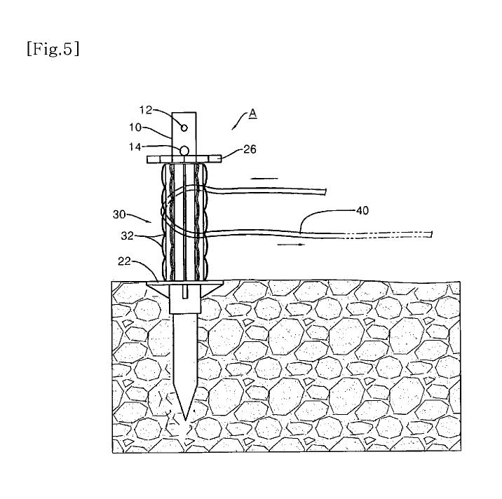

FIG. 6 shows an example where the hose-guide tool of the present invention is used.

### LISTS OF REFERENCE NUMERALS IN THE DRAWINGS

| | |
|---|---|
| A: hose-guide tool | 10: fixed pole |
| 12: engaging hole | 14: fixing pin |
| 20: fixed pipe | 22: pedestal end part |
| 24: thread engaging part | 26: catching end part |
| 30: rotating guide pipe | 32: concavo-convex part |
| 40: hose | 45: spray nozzle |
| 50: agricultural chemical tank | 60: hose drum |

### DETAILED DESCRIPTION OF THE INVENTION

An example of the hose-guide tool for spraying agricultural chemicals of the present invention constructed as above will be described with reference to the attached drawings as follows.

The hose-guide tool (A) according to the present invention is provided in the plurality for its use. Immediately before spraying the agricultural chemicals on crops, each fixed pole (10) is fixedly installed on one side of pathway of crop cultivation filed, and then a fixed pipe (20) and a rotating guide pipe (30) are joined with the fixed pole (10), respectively to form the hose-guide tool (A), and a hose (40) for spraying the agricultural chemicals can be guided by means of a plurality of the hose-guide tools.

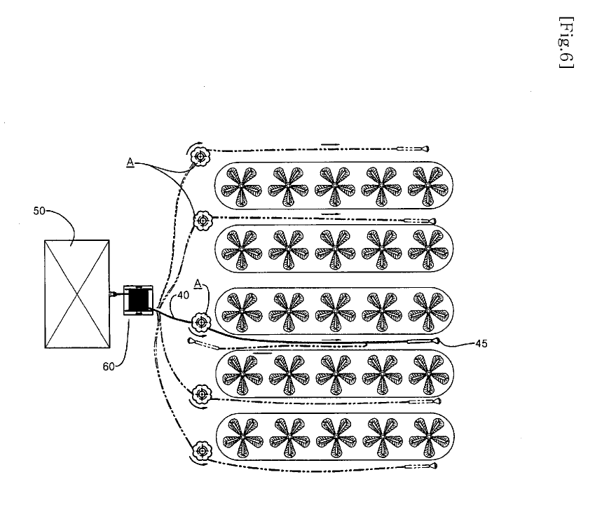

Namely, as shown in FIG. 6, each hose-guide tool (A) is installed on one side of the pathway defined by a furrow on one side of the crops, and thereafter a worker sprays agricultural chemicals, pulling the hose (40) connected to an agricultural chemical tank (50) and wound on a hose drum (60), while moving along the pathway with the hose being contacted with the rotating guide pipe (30) of the hose-guide tool (A), wherein the hose (40) can be easily pulled by means of the rotating guide pipe (30) rotated and the hose (40) cannot deviate from the pathway, whereby damage on the crops is prevented.

At this time, since pulling action of the hose (40) is implemented by means of the rotating guide pipe (30) positioned between a pedestal end part (22) and catching end part (26) of the fixed pipe (20), the hose (40) is prevented from deviating upward from the rotating guide pipe (30), and if the pedestal end part (22) of the fixed pipe (20) is arranged contacting with ground surface, even when the hose (40) falls down on the ground surface, pulling of the hose (40) naturally causes the hose to contact with the rotating guide pipe (30), whereby pulling action of the hose is smoothly implemented.

Furthermore, when the worker normally sprays the agricultural chemicals while returning from an end of one pathway, if the hose (40), which has been pulled via the rotating guide pipe (30) such that unwound part of the hose is lengthened, is turned opposite to the direction in which the worker moved along the pathway, the remaining part of the hose except for a turn of the hose becomes straight, whereby damage on the crops can be avoided. In this connection, as shown in an example of FIG. 6, even if the hose-guide tool (A) is installed for its use on any one side of the pathway, the hose can be pulled without damaging the crops.

Furthermore, it goes without saying that the hose-guide tool (A) may be fixedly installed at various positions optionally set depending on properties of the crop cultivation field and then guide the pulling action of the hose (40), and if spraying on the crops of the agricultural chemicals has been completed, the hose-guide tool (A) may be used in the state of being fixedly installed for subsequent spraying of the agricultural chemicals, or the hose-guide tool (A) may be removed and thereafter re-used.

As above, the present invention has been described with reference to the above example, but it goes without saying that various modifications can be made within the scope of technical concepts of the present invention.

The present invention provide the hose-guide tool for spraying the agricultural chemicals which is fixedly installed on one side of the pathway of the crop cultivation field and can guide the hose such that the pulling action of the hose is facilitated and also the pulled hose does not deviate from the pathway, thus allowing an agricultural chemical-spraying worker alone to conveniently spray the agricultural chemicals, pulling the hose such that unwound part thereof is lengthened, while moving along the pathway between the crops, and preventing the damage on the crops.

The present invention has advantages that while agricultural chemical-spraying work is performed pulling the hose connected to the agricultural chemical tank, the hose can be easily pulled by means of the hose-guide tools each installed on one side of the crop cultivation field and a single worker alone can stably and conveniently spray the agricultural chemicals while preventing the crops from being damaged by the hose, whereby work efficiency can be greatly enhanced and the hose-guide tool can fixedly installed in a simple and convenient manner.

What is claimed:

1. A hose-guide tool for spraying agricultural chemicals, wherein the agricultural chemicals is sprayed on crops through a hose connected to an agricultural chemical tank, the tool comprising:
a fixed pole (10) fixedly installed in a crop cultivation field;
a fixed pipe (20) joined with the fixed pole (10) to prevent the hose (40) from deviating upward and downward; and
a rotating guide pipe (30) rotatably joined with the fixed pipe (20) to guide pulling action of the hose (40).

2. The hose-guide tool for spraying agricultural chemicals according to claim 1, wherein the fixed pole (10) consists of a rod of a predetermined length, and a lower end part of the pole is made in the form of a needle, and fixing pin-engaging holes (12) are formed in multi-stage on side surface of upper end part of the fixed pole, and a fixing pin (14) can selectively engage the holes, whereby the fixed pipe (20) is prevented from deviating upward from a position of joining height and can be kept in a fixed state by the fixing pin (14).

3. The hose-guide tool for spraying agricultural chemicals according to claim 1, wherein the fixed pipe (20) has a pedestal end part (22) integrally formed on outer circumferential surface of its lower part for supporting the rotating guide pipe (30), and thread engaging part (24) is formed on outer circumferential surface of its upper end part, on which engaging part is fixedly screwed a ring-like catching end part (26), and the rotating guide pipe (30) is joined on the outer circumferential surface between the pedestal end part (22) and the catching end part (26).

4. The hose-guide tool for spraying agricultural chemicals according to claim 1, wherein the rotating guide pipe (30) is rotatably joined between the pedestal end part (22) and the catching end part (26) and has a plurality of concavo-convex parts (32) formed on its outer circumferential surface for preventing slipping of the hose (40).
